(19) United States
(12) Patent Application Publication
(10) Pub. No.: US 2009/0193028 A1
(43) Pub. Date: Jul. 30, 2009

(54) FOUR DIMENSIONAL (4D) INFORMATION DISTRIBUTION SYSTEM AND METHODS

(76) Inventor: Richard D. Kaplan, New York, NY (US)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 12/019,251

(22) Filed: Jan. 24, 2008

(51) Int. Cl. G06F 17/30

(52) U.S. Cl. 707/10; 707/E17.001

(57) ABSTRACT

The present invention provides for a four dimensional (4D) information distribution system and method which allows on-demand and real-time transmission of time-sensitive and useful self-help data or instructional materials to user. The transmission of the 4D information can be initiated at the user's request or it can be automatically carried out based on a set of established rules, such as a schedule of events. The 4D information distribution system includes a processing device for generating the 4D information, a distribution device for transmission of the 4D information, a receiving device for accepting the 4D information, and a display device for outputting the received 4D information.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### RELATED APPLICATIONS

The present application incorporates by reference each of the applications associated with the following serial numbers in their entirety by reference thereto: U.S. patent application Ser. No. 11/728,689 filed on Mar. 26, 2007; U.S. patent application Ser. No. 11/634,460 filed on Dec. 5, 2006; U.S. patent application Ser. No. 11/634,486 filed on Dec. 5, 2006; U.S. patent application Ser. No. 11/634,487 filed on Dec. 5, 2006, U.S. patent application Ser. No. 11/634,718 filed on Dec. 5, 2006; and U.S. Patent Application 60/833,742 filed on Jul. 26, 2006.

### BACKGROUND

The present invention generally relates to a system and method for distribution of four dimensional (4D) information, or 4DHelp information, to users, and more specifically to on-demand and real-time transmission of time-sensitive and useful self-help data which enable innovative and complex user interactions with the 4DHelp information, along with an additional set of data pertaining to the self-help data that may be of potential interest to the users, such as advertising and business listings.

Currently, there exist many self-help mechanisms that attempt to expedite a user's problem-solving process by providing information relating to the user's problem, or product, at hand. For example, desktop help menus are designed to be searchable by topic, so that a user can access information pertaining to a specific subject matter or owner's manuals containing voluminous product information are provided to users for future reference when they purchase products. However, these systems fail to fully meet a user's problem-solving requirement in today's mobile and demanding consumer environment because they typically provide static information mostly in the form of two dimensional (2D) flat printed materials that cannot dynamically adapt to the user's needs in real-time and in a manner that is most suitable and convenient for the user.

Existing self-help systems only provide generalized, static (2D), and potentially obsolete information that is not customized to the user's specific needs. For example, a printed user manual provides a generalized instruction tool for the user to navigate for finding specific information, such as how to perform a particular function on a motor vehicle. This information is usually text information, printed figures, or other non-interactive materials. As a further example, an electronic help menu may be text and some related static figures, but does not include active video or interactive three dimensional instructional materials that are in motion, such as 4DHelp information. Additionally, these static manuals, as they are updated, the old manuals must be discarded or replaced as being obsolete, thereby wasting significant amounts of paper, ink and associated costs.

These existing systems cannot intelligently understand or anticipate the user's potential interest so that the systems also fail to provide additional information that could be of significant value to the user. For example, while some existing systems provide repair instructions to users, they do not have the ability to determine that the users may also be interested in business listings for repair services in addition to the instructions.

Existing self-help systems are inherently static (2D) in nature, only providing a one-way communication between the user and the information. That is, once the user requests a set of information and receives the requested materials, the user's interactive experience ends, and the user cannot immediately make additional inquiries pertaining to a subset data of the requested materials. Should the user need further specific information, the user must then resort to additional sources, such as researching through a Frequently Asked Questions (FAQ) section, calling a help line to talk to a customer service representative, or employing other techniques for finding the additional information.

Current self-help systems may also lack time-sensitivity. For example, because a user may not carry along a digital camera's owner's manual, when a problem with a digital camera occurs, the user must either blindly figure out the problem or delay use of the product until the manual can be referenced. In other situations where an electronic device may include an electronic copy of the user manual or help menu on the device, for example a laptop computer or a mobile phone, the user is still limited to the existing static (2D) help data on the device.

There currently exists mobile user assistance techniques, but these solutions fail to provide interactive three dimensional capability. One example of a mobile user assistance technique is an in-vehicle navigation system that uses a GPS device to monitor and track a vehicle position relative to a database of routing information. This system uses a static 2D flat topographical map and tracks the vehicle progress on the map. The user is provided limited interaction based on the visual feedback of watching the vehicle position updated on the screen, but is not afforded direct interactive capabilities in a 3D environment, but are rather specifically limited to 2D static maps.

There also exists three dimensional assistance guides, but these lack mobility, interactivity, and timeliness. For example, an item might come with a “how to” video, but these videos by their very nature are static and lacking interactivity. As with manuals, they also lack portability such that the user must have the item or access to the item in a time-sensitive manner to retrieve the requested information. As the complexity of electronics, consumer items and other elements of the modern world increase, so does the complexity of usability of these items. There currently does not exist a proficient system combining the various elements and techniques to thereby provide interactive 4DHelp information and pertinent sub-information to users operating in a mobile environment.

### BRIEF DESCRIPTION OF THE DRAWINGS

FIG. 1 is a functional block diagram illustrating one embodiment of the system overview of a 4DHelp information distribution system.

FIG. 2 is a flow chart illustrating one embodiment of the sequence of steps in a 4DHelp information distribution method.

FIG. 3 is a data flow diagram illustrating one embodiment of the distribution of 4DHelp information to assist a user encountering a vehicle emergency.

FIG. 4 is a block diagram illustrating one embodiment of a mobile device used in the 4DHelp information distribution system.

FIG. 5 is a block diagram illustrating another embodiment of a mobile device used in the 4DHelp information distribution system.

FIG. 6 is a screen shot illustrating one embodiment of a user interface for a mobile device used in the 4DHelp information distribution system.

FIG. 7 is a block diagram illustrating one embodiment of the data structure used to implement the 4DHelp information data.

FIG. 8 is a block diagram illustrating one embodiment of a method for distribution of directed advertising as the 4DHelp information to a user and its associated database arrangement.

FIG. 9 is a block diagram illustrating one embodiment of a data repository with user accounts used in the 4DHelp information distribution system.

### DETAILED DESCRIPTION OF THE DRAWINGS

The present invention relates generally to interactive three dimensional in motion data (“four dimensional information”) and a distribution system for providing this data to an end user. The interactive three dimensional data is also referred to by the name four dimensional Help (4DHelp) data, as this data includes information more advanced than three dimensional animations or images, enabling the end user to navigate and manipulate this 4DHelp data. Alternatively, because the present invention includes the use of interactive three dimensional data as introduced above, 4DHelp can also be referred to as i3DHelp. The 4DHelp data includes the interactive three dimensional data being, manipulatable, navigatable, and/or rotatable over time. Additionally, this 4DHelp data may be enhanced with text and multi-party interactive natural voice functionalities, such as with speech recognition applications or interfacing to a live person. Through the distribution system, the interactive data is received and processed by a handheld or other remote device, allowing the end user to manually interact with the information, as requested.

Concurrent with 4DHelp product data, the invention further includes system information associated with various consumer products and other elements or features for which 4DHelp data may be used. One embodiment envisions a universal identification system to quantify and organize items. For example, a universal descriptive code may be applied to one or more components to provide for one of numerous available searching or otherwise identifiable techniques to allow a user time-sensitive access to information. From this universal identification system, corresponding 4DHelp data may be accurately and timely retrieved, such as using a remote device for providing a two dimensional display of the 4DHelp data which can be implemented as interactive three dimensional data.

The invention encompasses numerous aspects of the dynamic 4DHelp system. The front end includes the acquisition of the three dimensional information and the creation of the four dimensional 4DHelp information. In one embodiment, the 4DHelp information may be acquired from existing databases or other repositories of engineering information. For example, a manufacturing company may already include a repository of existing engineering or CAD-based drawings, such as an automotive manufacturing company having three dimensional CAD figures associated with various car parts and assembly drawings, which can be converted into 4DHelp information.

In another embodiment, this 4DHelp information may be generated using one or more various three dimensional modeling or CAD-based software programs. It is recognized that there are additional techniques for the data acquisition and storage, where the underlying data includes three dimensional information in 4DHelp data format, which may in one embodiment be represented in a two dimensional display.

In addition to the three dimensional components, the 4dHelp information further includes the ability for user interaction, as described above, being the fourth dimension in the 4DHelp data. This interaction component may include one or more levels of information allowing for interfacing with a user interface. For example, the 4DHelp data may include meta data associated with different components or views, where a user interface utilizes the meta data for providing different levels of interaction. For example, as described in further detail below, different 4DHelp data fields may be designated as a wheel assembly for a particular vehicle or number instruction displays for the changing of a particular tire. In another embodiment, the interaction information may be directly encoded into the 4DHelp data, usable by the user interface. Through this meta data or other levels of interaction guiding information, the interface application can then allow for the end user to have the 4DHelp information be interactive. For example, if a user seeks to rotate a particular view, voice commands may be recognized to adjust the display to another three dimensional view, thereby providing real-time 4DHelp illustration of the rotation of the three dimensional display of the underlying object or element being described.

In one operation of the invention, a user may seek to access the four dimensional information in a time-sensitive manner. The invention includes the ability for this information to be accessed, in one embodiment, using a remote or mobile device or processing system having the ability to make a wireless connection, such as a wireless enabled computer. The invention may utilize any suitable interface allowing a user to connect to an information retrieving system, such as directly connecting to a wireless service or logging onto a web-based portal or site, for example. In one embodiment, the user may enter account information or login information, if requested.

Through this connection, the user may then provide input data indicating the requested information. Various embodiments are envisioned, as recognized by one having ordinary skill in the art, for requesting information. One technique may include scanning or submitting a photograph of a component or identifier. For example, if a product has a universal identification code, this may be photographed, scanned, typed in by the user, spoken, among other input techniques. Another technique may include wirelessly reading information from the device itself, such as from an RFID tag or wireless data chip, for example.

Through the various data submission techniques, the service program may then access a database or repository of 4DHelp data to retrieve the corresponding information. In another embodiment, further operating steps may be performed to narrow the scope of information, such as asking the user for more specific information being requested or a purpose of the information. Once the proper 4DHelp data is retrieved, this information may be submitted to the remote device. In the embodiment where the remote device is wireless, the transmission may be across a wireless network. In an embodiment where the remote device includes a hard-wired connection, the 4DHelp data may be transmitted using known hard-wired transmission techniques.

The invention may include software applications capable of playing 4DHelp information. It is further envisioned that this 4DHelp information be interactive, such as allowing a user to enter and receive natural language instructions and responses. For example, a person with a flat tire may ask the question: “where do I place the jack?” and this could be translated to provide a 4DHelp display of the jack-designated location on the side of the car. It is also recognized that natural language queries can be made available on the front end, such as a person asking “how do I change the tire on my 2005 Volkswagen?”, for which such a person would receive human or avatar natural language responses.

Other embodiments of this invention include the pre-population of 4DHelp data on a product or wireless device prior to its sale. For example, data storage means permitting, a company that sells a mobile device may include 4DHelp data for all or a subset of its electronic components with the wireless device. In one embodiment, as a user purchases different products, the information may be provided to the remote device, such as during downtimes. For example, suppose a user has a wireless device manufactured by a particular electronics company and then purchases a video disk player by the same company, upon registration of the disk player, the company may push the 4DHelp data to the user's remote device allowing the user time-sensitive access to product information. Additionally, this service may be provided in conjunction with co-operating agreements, such as purchasing an item by one company and registering that product may allow a wireless service provider to provide users with this specific information.

In another aspect, the 4DHelp data may also facilitate the inclusion of advertising or other directed messages. The advertising may be sponsored by the 4DHelp data creator (e.g. advertising other related products/accessories in a 4DHelp manual for another product), or may advertise third party products in exchange for advertising fees. In this respect the 4DHelp system can be used to generate advertising revenue and additional sales. In the above example of a flat tire, an intermediate server or service application may recognize one or more messages related to the flat tire and provide such messages in conjunction with the tire changing information. By way of example, one type of directed message may be an advertisement for a tire sale at a local auto store or an advertisement for a membership application to a local automobile club. It is recognized that additional direct message information may be included, such as warranty information in the event vehicle needed to be towed or was covered under a roadside assistant program or other scenarios. Regardless of the specific-listed embodiments, the 4DHelp data and the distribution system allows for the inclusion of the directed message to the user in a timely manner consistent with a user's apparent need.

All of the 4DHelp data may be kept in a single repository, e.g. a data vault, or in a plurality of repositories, which may be distributed (e.g. over a network such as the Internet). A repository may be, but does not necessarily need to be owned, controlled and/or maintained by the 4DHelp user. Alternatively, there may be a primary repository, which may only maintain a list of links to 4DHelp maintained on external data repositories. A system associated with the repository may allow for the creation of user accounts, where a user's specific 4DHelp data may be maintained. The users may then log into the repository system and perform any number of functions. For example, a user may maintain a personal 4DHelp vault or repository where certain relevant 4DHelp data is associated with the user's automobile, television, cellphone, pda/smart-phone, etc. It is also possible for the user to add data to the repository for equipment not owned by the user. For example, if a friend loaned a user a digital camera, and the user was having trouble using it, the user may log in to the account to add the 4DHelp data for that camera to the user's repository. As discussed above there are many ways to acquire the data, and all 4DHelp data acquired by a user may then be associated with the user's account. Using the system, the user may perform other actions, like disassociating 4DHelp data, modifying 4DHelp data, customizing 4DHelp data, or other similar actions. The system may provide tools and a framework for users to create their own 4DHelp information for themselves and/or to share with other users. This content may be stored by the system, and created content (e.g. created by product manufacturers, or users) may be sent to, received by, and stored by the system.

Alternatively or additionally, the third party creators (e.g. a product designer, manufacturer, or any other independent creator) may create 4DHelp information or data for equipment manufactured or sold by others, serve that information independent of the system, and the system may link to the 4DHelp information without actually copying the information to the system or user data repository. Third party creators may send the 4DHelp data (or a link) to the system, and/or the system may use one or more known search techniques to find and index the 4DHelp information which is accessible. It is additionally possible for users to store their personal 4DHelp data on a personal computer, including a cellphone, notebook, desktop, pda, etc.

Additionally, when a user purchases a product the 4DHelp information associated with that product may automatically be associated with the user. In one embodiment, the user may need to give an identifier and/or password to allow that association to take place, in another embodiment the system could be tied to the retail computers such that the very act of purchasing something will associate the 4DHelp data with the user's repository of 4DHelp data (or alternatively does not immediately go into the user's repository but into a “content you may want to add” list presented to the user at some point, e.g. logging into the system).

An additional feature may be to provide a 4DHelp social network. For example, if a user purchases a new car, that user may automatically be associated in the 4DHelp system with other users who have purchased a similar car. The associated users my then have access to discussion forums and content creation tools to help each other with issues related to the common product. In this regard, the 4DHelp system may assist with the identification of product flaws and/or may help manufacturers evaluate product longevity or part replacement time tables. In another embodiment, user associations may occur whenever users associate themselves with the same or similar 4DHelp information, through purchases and/or through selection of product categories; for example “Audi® car repair,” or “tire replacement.” Other features are possible, such as setting a user status as “available” indicating the user is willing to receive emails, instant messages, or other communication from other 4DHelp users regarding a common product or question on a topic. In this way a user may be changing the tire of his or her car, and have an issue with the lug nut for example. The user then may have the option of connecting with a customer service representative for the car manufacturer, going to a discussion forum associated with the car, or a discussion thread associated with the lug nuts to see what other users have said about the part. However, if the wait time for any of those options is long, and/or if no useful information is found in the discussion forum or other information tools available, the user may check for “available” users who are also associated with the specific car (e.g. in their 4DHelp social network for that item) and be put in communication with one or more of those users (e.g. via email, instant messaging, text messaging, or a phone call). It's entirely possible that a user fixing a tire on a specific model car is doing so at the same time another user is fixing a tire on the same model car. The system can determine this based on 4DHelp accesses and facilitate a communicative connection between those users so they may help each other through the process.

In addition to advertising relevant to the specific 4DHelp data being used at the moment (e.g. suggesting a local repair shop while viewing a “how to change a tire” 4DHelp), the 4DHelp system may provide relevant information for other relevant, though not as immediate, advertisements. For example, say a 4DHelp user is logged into his or her repository account. They seem to be in no immediate need of any particular product, but advertisements may still be displayed somewhere on the account interface. The system may chose relevant, though not urgent, advertisements based on the content and usage of their personal account repository. For example, say the user has a 4DHelp manual for a ten year old car, it may be the case that this user is more likely to be in the market for a new car than someone with a one year old car. Patterns, user tendencies and/or content may be observed, and/or evaluated. For example, a user who has new 4DHelp content associated with his or her account every five years, which is associated with a new car, may have car advertisements presented to the user around the time 4.5 to 5 years since the last one, but may have other types of advertisements shown to him or her at other times. Identifying patterns in the 4DHelp system may allow more effective and useful advertising for both the advertisers and users. The advertisements may be for related products by the 4DHelp data creator, or advertisements may be for third party items who pay an advertisement fee.

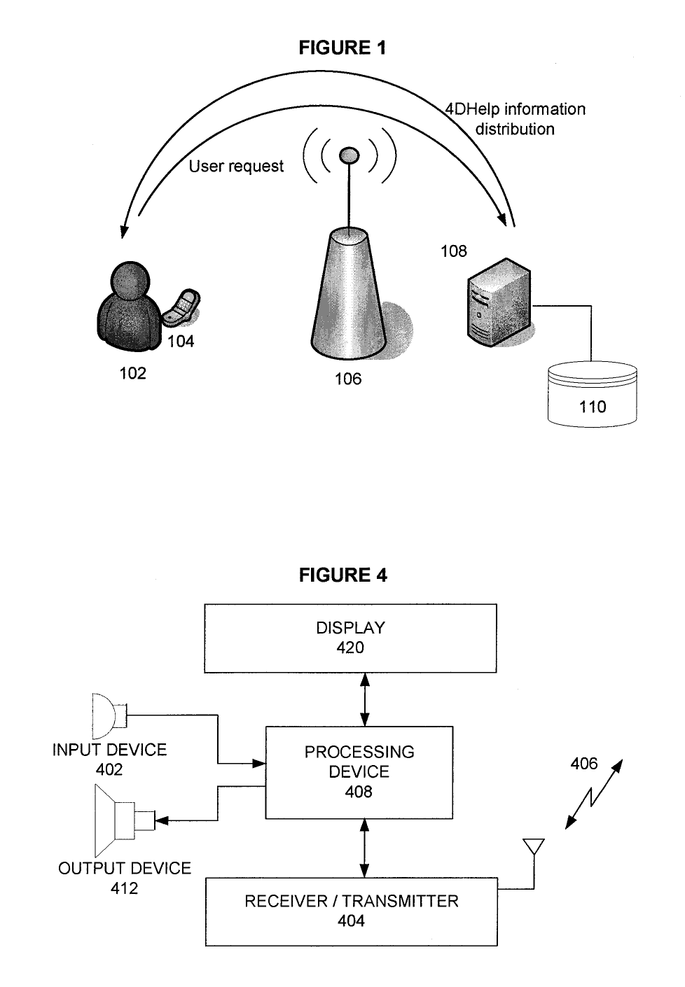

FIG. 1 is a functional block diagram that illustrates one embodiment of a 4DHelp information distribution system 100. The system 100 includes a user 102, a mobile device 104, a wireless transmission device 106, a backend server 108, and a database 110. The mobile device 104 may be a mobile phone, a PDA, a mobile computing device having wireless capabilities, a smart phone, or any other suitable type of the mobile device 104 as recognized by one having ordinary skill in the art. The wireless device 106 may be one more wireless systems that may include connectivity to one or more networks, such as the Internet or a proprietary network using known connecting techniques and protocols. The backend server 108 may be one or more processing devices capable of receiving communication and accessing the database 110 as described in further detail below. The database 110 may be one or more of any suitable type of data storage device capable of storing interactive 4DHelp data as described in further detail below.

As illustrated in FIG. 1, the user 102 operates the mobile device 104. User 102 sends a user request via the wireless network 106 for assistance with a personal encounter, such as, for example, a vehicle or medical emergency. In the exemplary case of a medical emergency, user 102 may need instructions on how to perform CPR on another individual. User 102 sends a request to receive such instructional materials by inputting a message via a voice command function on the mobile device 104: “Please send me CPR instructions.” As discussed in further detail below, in alternative embodiments, the user's input may be accomplished by text input on a display, scanning an object such as a barcode or a radio frequency identification device (RFID) tag, or any other suitable input techniques.

In this example, the user's request is transmitted through the wireless network 106 where the processing device 108 interprets the user request and retrieves the requested data from the database 110. In this embodiment, the database 110 stores medical instructional materials in the form of interactive 4DHelp data, as described in further detail below, and communicates the requested CPR instructions to the processing device 108. In another embodiment, the data stored on database 110 can be 2D data, such as static figures and text.

To continue service to the user 102, the processing devices 108 receives the 4DHelp data from the database 110 and transmits the interactive 4DHelp data to the mobile device 104 via the wireless network 106. The mobile device 104 receives the 4DHelp data from the processing device 108 and displays an output on a display device, such as a screen on the mobile device 104. The display device may contain capabilities of outputting the 4DHelp data as a video output, which may include an audio component, as well as text or audio capabilities for user interaction. In the present example, the received 4DHelp data may be outputted by the display device housed in the mobile device 104 as a maneuverable 4DHelp image of an individual giving CPR to another individual, so that user 102 may touch the screen of the display device or any other input device such as a plurality of buttons, voice commands, a rotary wheel, among others, to rotate, zoom, and move the 4DHelp image for better viewing perspectives. As described in further detail below, the generation of maneuverable 4DHelp images can be implemented using any suitable digital imaging or computer animation techniques, such as those presently known in the art.

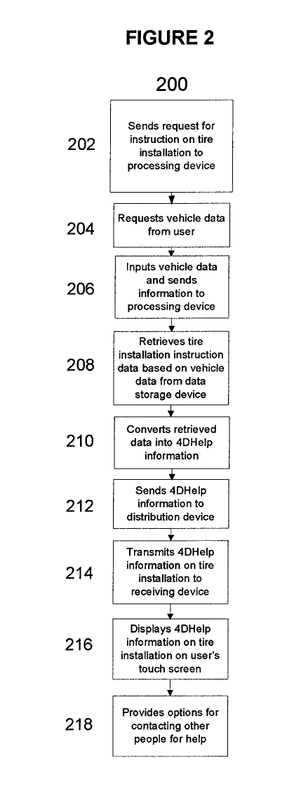

FIG. 2 is a flow chart that demonstrates one embodiment of a 4DHelp information distribution method 200. This exemplary method relates to an embodiment of a user requesting interactive 4DHelp information for changing a flat tire. The method may be initiated by a user request in step 202, which sends a request for instructional materials. Next, in step 204, a receiver of the user request, such as a processing device similar to the processing device 108 described above with respect to FIG. 1, sends an inquiry for vehicle data from the user in order to retrieve 4DHelp instructional materials that are customized for the user's particular vehicle. In step 206, the user inputs the necessary vehicle data, such as vehicle model, make, year, and tire component identification, and sends the information to the processing device. In one example, there may be a bar code in the owner's manual or on the inside panel of a door, where this bar code may represent the vehicle information. In another example, an RFID tag may be embedded in the vehicle so that an RFID tag reader housed in the mobile device can read this information. In yet another example, the mobile device may be an internal computing system, e.g. navigation system, on the vehicle so the 4DHelp information may already be included in the above-mentioned mobile device.

In step 208, the processing device retrieves data instructions for changing a flat tire from a data storage device similar to the data storage device 110 described above, according to the vehicle data received from the user. This spare tire installation may include steps for placing safety flares in the road, removing a jack and the spare tire from the trunk, jacking up the car, removing the flat tire, installing the spare tire and replacing the tire jack in the vehicle. After the data storage device communicates the requested tire installation instructions to the processing device, the processing device may convert the raw data into 4DHelp information by enabling user interaction with the images rendered by the 4DHelp information in step 210. As described in further detail below, this may include associating interactive data to the 4DHelp information, which allows for a user to interact with the instructions, interrupt the instructions for asking non-sequential instructions, contacting additional sources of assistance, or other interactive or assistance techniques.

Thereafter, in step 212, the processing device sends the 4DHelp information to a distribution device, which transmits the 4DHelp tire installation information to a receiving device in step 214. In step 216, the receiving device houses a display device which visually outputs the 4DHelp tire installation information on the user's touch screen as a 2D display of interactive 4DHelp images, and the user is able to maneuver the images as necessary. Finally, in step 218 the user may be provided options for contacting other people to get help. This may be because the 4DHelp information does not address the user's specific complaint, the user is having difficulty understanding the information, or some other reason. The contact option may include contacting an official customer service person (e.g. at a call center), or may include for example getting in contact with another user via a social network. Contacting other users may include email, text messages, real-time chat, or any number of other methods of communication, and a social network may include for example all the 4DHelp users who similarly downloaded the specific piece of 4DHelp content. Additionally, the user may utilize the other elements of the mobile device for interactive capabilities with the 4DHelp information, such as described below with respect to FIG. 4.

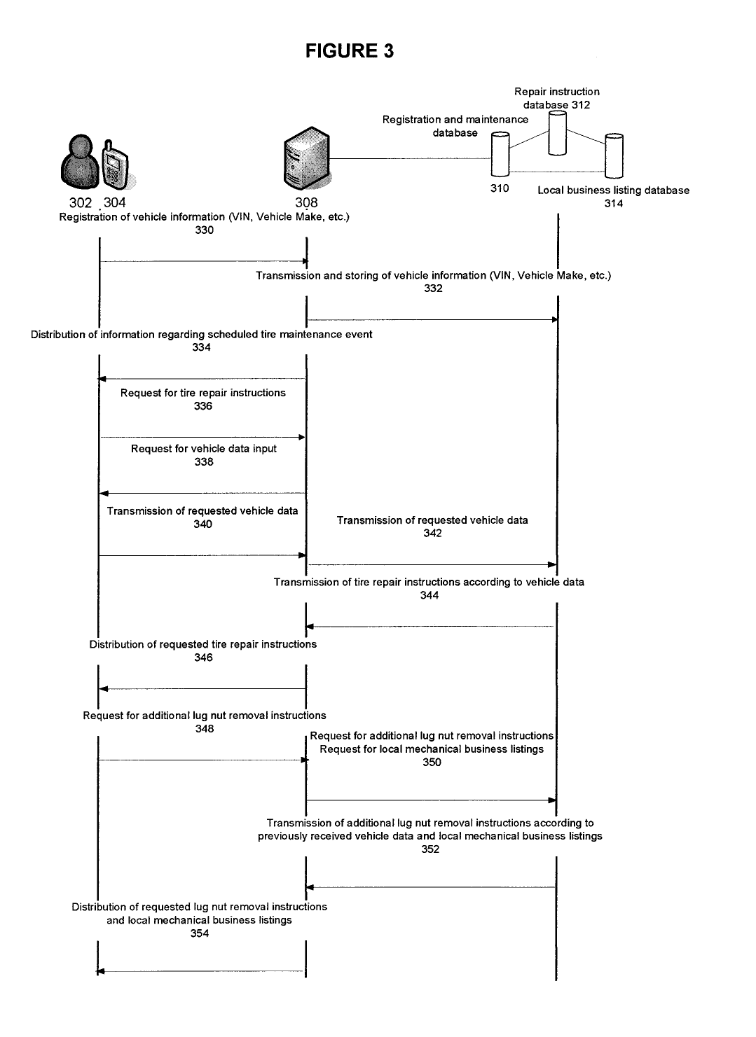

FIG. 3 illustrates a data flow of one embodiment of the utilization of interactive 4DHelp information. In this 4DHelp information distribution example, truck driver 302 carries a mobile device 304, whose functionality and examples are described above for the mobile device 104 illustrated in FIG. 1. When truck driver 302 first purchased the vehicle, the purchaser may have registered the vehicle's data and a corresponding maintenance schedule by scanning an identification code located on the truck with an RFID scanning device for example, which can be implemented inside the mobile device 304, in 330. The registration may have been automatic at the time of purchase. The identification code had been previously configured by the truck manufacturer before the vehicle left the manufacturing facility; it uniquely identifies the truck by capturing information including vehicle make, model, year, and various data for the components in the truck, including tire model. Additionally, the identification code also captures a schedule of maintenance events that is especially designed for the truck. When the user scans the truck's identification code with the mobile device 304, the vehicle's data as well as its maintenance schedule are transmitted to processing device 308, whose functionality is exemplarily described above for the processing device 108 illustrated in FIG. 1.

In 332, the processing device 308 transmits and registers the vehicle data and maintenance schedule in data storage device 310, whose functionality and examples are described above for the data storage device 110 illustrated in FIG. 1. In this example, the data storage device 310 maintains registration and maintenance information for vehicles. Additionally, the data storage device 310 is connected in a network of databases with data storage devices 312 and 314, which maintain repair instructions for vehicles and local business listings, respectively. The maintenance schedule may be a set of data that contains a date field, which indicates when a vehicle maintenance task should be completed.

The processing device 308 may perform periodic retrieval of 4DHelp data based on a date field in order to distribute reminder information. In this embodiment, the processing device 308 distributes reminder for tire rotation at a predetermined time period, for example three weeks before the vehicle maintenance due date, in 334. In this example, the user 302 may choose to ignore the reminder and continue to drive the truck without rotating the tires.

After certain passage of time, due to over usage of the truck's tires, one of them becomes flat and the truck breaks down on the side of the road in an isolated area. User 302 requests for tire installation instructions by making voice commands via the mobile device 304, in 336. The processing device 308 receives the user requests and responds with an inquiry for vehicle data in 338. User 302 inputs the vehicle data by scanning the vehicle's identification code with the mobile device 304, which transmits the requested vehicle data to the processing device 308, in 340. The processing device 308, in turn, transmits the vehicle data to data storage device 312 to retrieve the tire installation instructions customized for user 302's truck in 342. The requested instruction information is immediately collected and transmitted from the repair instructions database 312 in 344 and distributed to user 302 in 346. In an alternative example embodiment, instructions database 312 may be part of a data repository system which facilitates individual user data vaults. In this way the relevant data associated with a user's various devices, may be organized for that user and accessible via any number of methods including the above described user device 304.

Due to user 302's lack of experience with tire installation, the flat tire still cannot be replaced because user 302 does not know how to remove the lug nut from the spare tire. User 302 makes additional communication with the processing device 308 via the mobile device 304, which has maintained an open communication channel with the processing device 308 in the meantime to allow additional levels of user inquiries. User 302 sends a request for lug nut removal instructions to the processing device 308 in 348. In 350, the processing device 308 transmits the request to the repair instructions database 312 to retrieve lug nut removal instructions. At the same time, the processing device 308 determines that the additional user request means that user 302 is having difficulty with tire repair. As such, the processing device 308 locates the mobile device 304 via GPS capability implemented on the mobile device 304, and transmits location information to the data storage device 314, which contains a list of business listings. According to the location information received, the processing device 308 collects listings of automotive repair shops that are located near where user 302 encountered the vehicle emergency, along with lug nut removal instructions from the data storage device 312 in 352.

Finally, in 354, the processing device 308 distributes lug nut removal instructions as well as a set of local automotive repair business listings to the mobile device 304 for output to user 302. As with previous instructions, the lug nut removal image may be a 4DHelp display with user interaction, such as allowing a user to rotate or otherwise manipulate the image, such as for example viewing the lug nut removal from a different perspective. From the mobile device 304, user 302 may choose to call an auto shop by dialing the telephone number displayed for expert assistance with tire replacement. As discussed in further detail below with respect to FIG. 8, various types of additional data may be included with the interactive 4DHelp data, including advertising information, club membership information (e.g. auto club information for a flat tire) or other suitable information, which may be pertinent to the subject of the 4DHelp.

FIG. 4 is a block diagram that illustrates one embodiment for a mobile device component used in the 4DHelp information distribution system. The mobile device comprises an input device 402, which accepts and interprets input from a user, such as a microphone capable of voice command functions, or a keyboard with text input capabilities. It also includes receiver/transmitter 404, which operates to transmit user requests initiated by the user and receive the requested data via a networked communication environment or a wireless environment 406. The receiver/transmitter 404 may operate in accordance with any known mobile techniques for transmitting and receiving communications.

Additionally, processing device 408, whose exemplary functionality is described above for the processing device 108 in FIG. 1, can be implemented to provide visual display of all or portions of the received data and enable adjustment of the visual display by the user in display 420. The adjustment of the display may be accomplished using any suitable interactive technique, such as a tactile interface to allow a user to rotate an imagine, a touch screen interface to allow a user to perform various touch screen operations, voice input capabilities through various voice recognition techniques, on screen interactive commands, or any other suitable techniques as recognized by one having ordinary skill in the art.

Additionally, audio output device 412 can be implemented in the mobile device so that rather than visually displaying the data retrieved by the processing device 408, the retrieved data can be outputted in audio announcements to the user. In another embodiment, the input device 402 and the audio output device 412 are further equipped with natural language engines so that voice command functions are capable of recognizing natural languages.

In a further embodiment, the processing device 408 retrieves 4DHelp data from a data storage device that is implemented as a local memory within the processing device 408. Alternatively, in the wireless communication environment 406, the processing device 408 retrieves 4DHelp data from a data repository that is implemented as an external database or the data repository may be a network of external databases that store three or two dimensional data. For example, in the tire repair example provided in FIG. 3 above, the data storage devices 310, 312, and 314 can be maintained by various truck manufacturers, tire manufactures, and auto repair businesses who would like to provide better customer service by taking advantage of the 4DHelp information distribution system and sending maintenance reminders, repair instructions, and/or advertisements to customers.

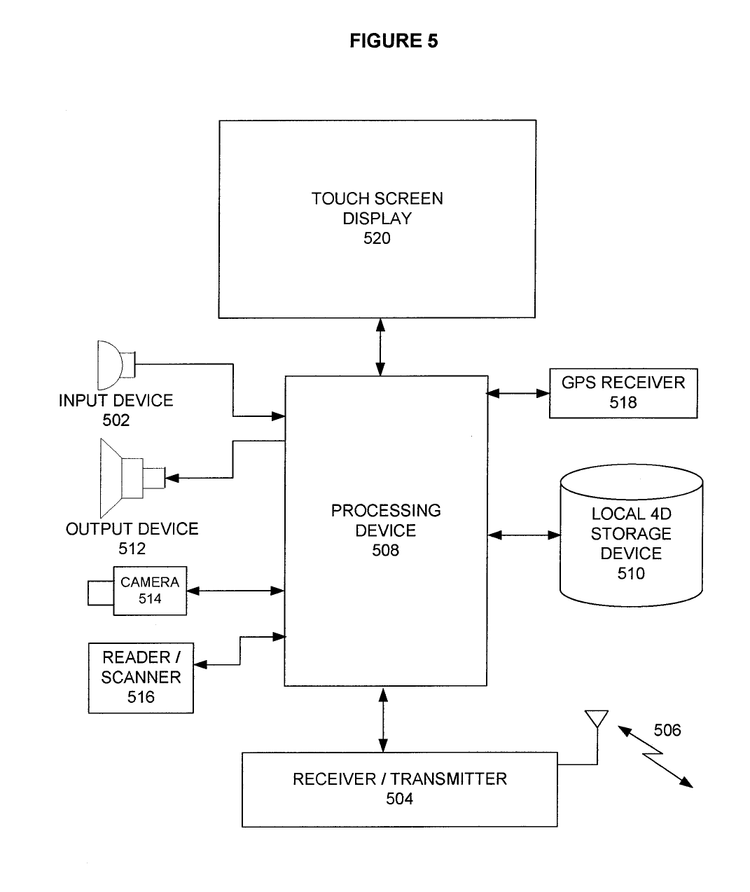

FIG. 5 is functional block diagram that illustrates another embodiment of a mobile device as a component in the 4DHelp information distribution system. The exemplary mobile device comprises a processing device 508, receiver/transmitter 504, display 520, input device 502, and output device 512. The processing device 508, receiver/transmitter 504, input device 502 and output device 512 may be similar to the mobile device components described above with respect to FIG. 4 and the display 520 may be similar to the display of FIG. 4, although including touch screen capabilities. Transmission of data can be accomplished via wireless network 506. Additionally, the exemplary mobile device also contains a reader/scanner 516, such as a radio frequency identification device, to enable user input by scanning an object, as described in the example embodied in FIG. 3 above. Further, the exemplary mobile device may include GPS receiver 518 to provide location information as usable with the mobile device in conjunction with the 4DHelp interactive information application.

In one embodiment, a camera 514 can also be implemented as an integrated component in the mobile device as an alternative identification device for the user. For example, instead of identifying the object that needs repair by scanning the object with reader/scanner 516, the user may use the camera 514 to take a picture of the object and transmit the image to the processing device 508 for identification. In another embodiment, the camera 514 may allow for visual feedback to an assistant, such as a customer service representative, for example if the user is having problems with an item, the user may take a picture or capture video of the problem and submit the visual feedback to the customer service representative in a proximate real-time fashion. More specifically, in the example embodied in FIG. 3 above, when user 302 does not know the name of the mechanical part that needs to be removed from the spare tire (i.e. a lug nut), the user may capture the lug nut pictorially using the camera 514 in the mobile device. Finally, a local data storage device 510, whose functionality is introduced above for the local memory in FIG. 4, is provided for the mobile device embodied in FIG. 5, to allow faster access of 4DHelp information that are helpful to the user. This device may be configured to interface with a user specific data repository (e.g. data vault) to retrieve 4DHelp information already associated with the user.

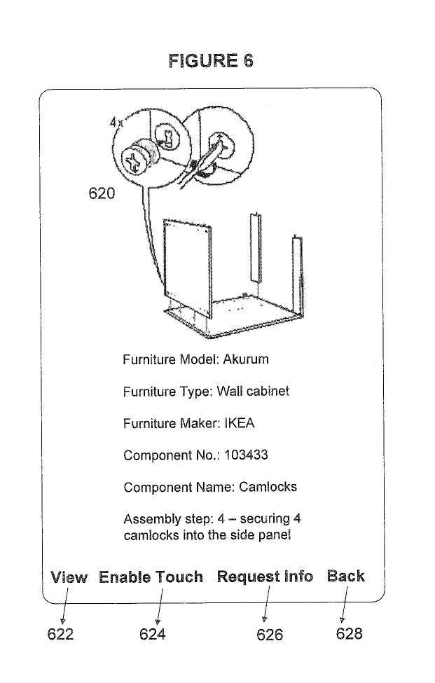

FIG. 6 illustrates a representative example of a screenshot that may be visible on a user interface of a mobile device used in the 4DHelp information distribution system. The user interface contains a touch screen display 620, whose functionality is described in further details below. In the embodiment illustrated, user is attempting to assemble a piece of furniture that was purchased from IKEA and has encountered difficulty in securing a set of camlocks into one of the side panels.

The user initiates a request by scanning an identification code located on the packaging for the camlocks with a receiver/scanner device known to one of skill in the art, including for example, the receiver/scanner 516 described in FIG. 5 above. After the receipt of the user request, a processing device, such as the processing device 508 described in FIG. 5, retrieves instructions regarding the camlocks from an external database storage device, such as the database storage device 110 described in FIG. 1, and transmits the instructions to the mobile device.

Continuing with this embodiment, the instructional information is displayed on the user interface. Specifically, the upper portion of the touch screen display 620 shows a 4DHelp image of a camlock being secured into a side panel. The middle portion of the touch screen display 620 shows text information regarding the furniture piece and component item. For example, in the embodiment described herein, furniture type is shown to be a “wall cabinet,” furniture maker is shown to be “IKEA,” component number is shown to be “103433,” and “assembly step” inquired is shown to be “securing 4 camlocks into the side panel.” Lastly, the bottom portion of the touch screen display 620 shows touch buttons that allow user interactions, such as “View” button 622, “Enable Touch” button 624, “Request Info” button 626, and “Back” button 628. The functionality of each touch button can be implemented according to available capabilities known to one skilled in the art. For example, “Enable Touch” button can be implemented such that after the user touches the button, the user can rotate the 4DHelp image shown on the upper portion of the touch screen display 620 by touching a particular part of the screen, and dragging the 4DHelp image with the touch of a finger. In the meantime, a new “Disable Touch” button is shown to be available to the user at the bottom portion of the touch screen display 620 such that the user can touch the button to disable the touch screen function.

4DHelp images may be generated in this system based on any suitable generation technique. As described below, the 4DHelp images include additional data allowing for user interaction, whereas the base 3D data field is available for multi-dimensional rotation. By way of example, a user may generate 4DHelp images based on three dimensional data using a commercially or publicly available software application, such as a graphics or CAD system or a sketch-up technique. As another example, the user may utilize a 3D scanner, such as one currently available from NextEngine to generate a 3D model. Additionally, the meta data may be assigned to the 3D data to thereby allow user interactivity. It is also recognized, the 3D data may be acquired from other existing sources, such as a CAD or design database, three dimensional mapping database, a video database or any other suitable source.

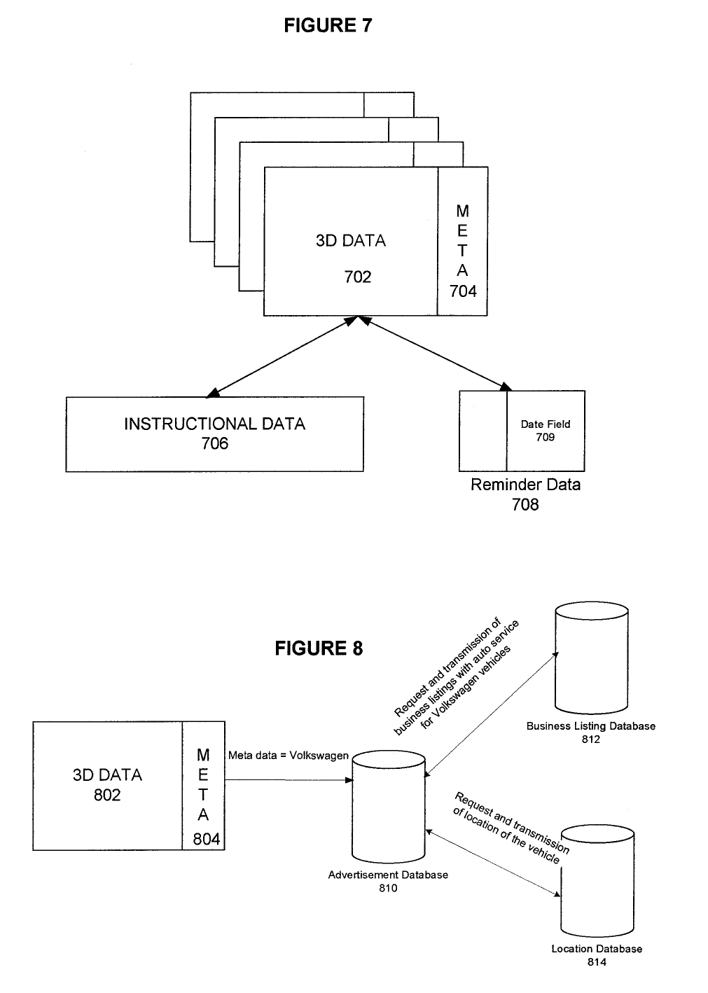

FIG. 7 is a block diagram that illustrates the data structure for the 4DHelp information as a component of the 4DHelp information distribution system. In the disclosed embodiment, the data structure includes three dimensional (3D) data 702, which can be implemented as any 3D data structure known to one skilled in the art, for example, as a sequence of frames of 3D data. The substance of the 3D data 702 may be any type of information, such as in various exemplary embodiments of product data or healthcare recommendations. In another embodiment of the invention, the 3D product data 702 may include CAD drawings from manufacturers, a product identifier (i.e. an unique identification code), maintenance information regarding the product, and product repair instructions. The data structure also includes meta data 704 which can be used to describe and identify each set of 3D data with which it is associated. For example, if the 3D data 702 contains product data directed to automotive parts for a 2007 Acura MDX, then the meta data 704 contains descriptors, such as “Acura,” “SUV,” “MDX,” etc. Finally, the data structure for the 4DHelp information may also include instructional data 706, which enables user interaction with the 3D data. In another embodiment of the invention, the instructional data 706 is an interactive program that maintains an open communication channel between an input source, such as a user of a mobile device with voice command functions, and an output source, such as an operator who provides real-time customer service to the user of the 4DHelp information distribution system. Alternatively, the instructional data 706 may be implemented as an interactive program that allows for radio frequency identification capabilities.

In further embodiments of the invention, the data structure for the 4DHelp information may also include reminder data 708, which can be data regarding a set of scheduled events, such as a vehicle maintenance schedule for the vehicle whose data is contained in the 3D data 702, and described by the meta data 704, or a healthcare checkup schedule. Reminder data 708 may be implemented to include date field 709, which indicates when a scheduled task should be completed, as described in example embodied in FIG. 3. Processing devices that are available to one of ordinary skill in the art, similar to components 108, 308, 408, and 508 as they are described in FIGS. 1, 3, 4, and 5 respectively, can retrieve and distribute the reminder data 708 to users based on the date field 709, such that users have sufficient time to respond and attend to the reminders.

The 3D data may be viewed or interacted with one or more types of existing applications. For example, one technique may include existing three dimensional interactive software, such as an iPix application. Additionally, the data may be viewed through a standard browser or other types of applications that allow for user interaction, including for example embedded image interaction buttons or queues. In another embodiment, a standard viewer may be combined with voice recognition and image rendering techniques, such as those found with video gaming consoles, to allow for the dynamic image generation or the three dimensional interaction based on user inputs. It is recognized by one having ordinary skill in the art that there exists various other techniques for displaying and facilitating the interaction of the 3D data. Please note that the above-discussed examples are not meant to be so limiting as noted herein.

FIG. 8 is a block diagram that illustrates one embodiment of a method for distribution of directed advertising as the 4DHelp information to users and its associated database arrangement. As described in previous embodiments, the distribution of advertisement can be accomplished in a networked or wireless communication environment. One embodiment of the proposed method includes the step of determining a user request seeking 4DHelp instructional data related to a Volkswagen vehicle as indicated by meta data 804, which describes the contents of 3D data 802, as similarly disclosed in the example embodied in FIG. 7. Once it is decided that the meta data 804 identifies information pertaining to Volkswagen, the directed advertising distribution method searches advertisement database 810, whose functionality and examples are described above for database 110 in FIG. 1, to determine promotional data that is related to Volkswagen vehicles. In another embodiment of the invention, the promotional data can be of one or more topics that are related to the subject matter indicated by the meta data 804. For example, promotional data can include coupons from Volkswagen dealerships, or offerings from automotive service clubs, such as AAA.

This embodiment of the invention further includes the steps of associating the promotional data with the 4DHelp instructional data initially requested by the user and providing the promotional data along with the requested 4DHelp instructional data to the user. To associate the promotional data with the 4DHelp instructional data, another embodiment of the invention allows a multi-media display to be embedded with the 4DHelp instructional data such that when the user activates the 4DHelp instructional data through actions such as enabling touch screen functionality, the related promotional data appears as a multi-media display.

In another embodiment of the invention, an additional layer of intelligence is added such that the method includes the steps of determining the location where the user entered the user request and selecting promotional information, such as business listings, based on the location. In this embodiment, the advertisement database 810 is organized as a relational database with connections to business listing database 812 and location database 814. The exchange of information amongst the databases 810, 812, and 814 ensures that the user receives business listings that are substantively relevant and physically accessible.

In a further embodiment of the invention, the user may register personal information, similar to the registration of vehicle data as described for the example embodied in FIG. 3. For instance, the user may choose to register personal contact information, car insurance information, state vehicle registration information, and automotive service subscriptions. It may be implemented such that another embodiment of the invention includes the steps of retrieving the stored personal information and selecting promotional information based on the personal information to provide further customization in addition to the location where the user entered the user request. For example, if the registered personal information indicates that the user is an MA member, then one embodiment of the invention selects an MA-participating vehicle towing business that is closest to where user is currently located.

The inclusion of pertinent or non-pertinent information includes other embodiments, such as a product warranty or registration. For example, a user may be allowed or granted 4DHelp capabilities for a product if they register the product with the manufacturer. Therefore, the pertinent information may pertain to the product itself or warranty information, such as indicating that the item is still under warranty and can be returned for authorized repairs. The data may also be non-pertinent, such as generalized advertising similar to banner advertising on a web page, where the initial advertisements are general but may be later customized based on further levels of user interaction.

Finally, the promotional information provided to the user can be in the format of an electronic message, such as a SMS message, an instant message, an electronic email communication or attachment, or a facsimile, depending on the mechanism at which the user will be receiving the information. Various other techniques are envisioned to encompass the distribution of additional information based on the access of the 4DHelp application, including sending additional information that can have additional levels of interactivity, such as an active link to a web site or a verification code for future online or offline activities, such as purchasing a new product based on the use of the help application, for example a $5 off coupon for an online retailer as an incentive for using the 4DHelp application.

Therefore, 4DHelp information is provided in a mobile environment, where the 4DHelp information is timely with interactive three dimensional information. This 4DHelp information includes 3D data with associated meta data structures as are readable by a mobile device. Additionally, back end systems allow for the recognition and inclusion off ancillary or additional data to the interactive three dimensional data transmitted in the mobile environment.

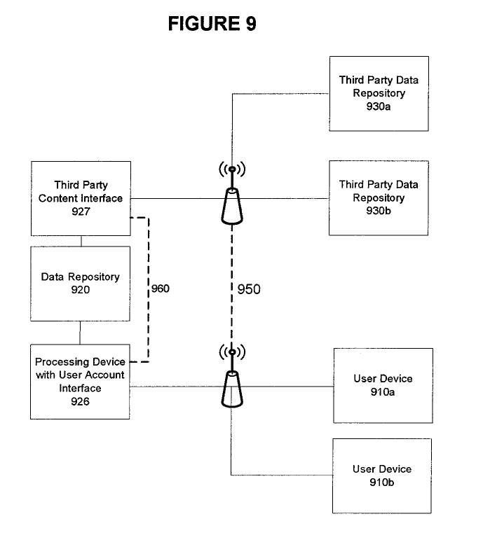

Another example illustration is given in FIG. 9. In this embodiment there is a Data Repository system 920, which may have storage (e.g. a database) for content libraries. There is a Processing Device with a User Account Interface 926 which allows one or more User Devices 910 to interface with the repository system. Each user device may have local storage available on the device. The Account Interface 926 may have account management features such as account creation and editing. Additionally, the Account Interface 926 may allow users to create a personal 4DHelp data vault (e.g. on the Data Repository system 920, or stored locally on the User Device 910) by associating 4DHelp data with the user account. User Device 910 and the Account Interface 926 may be connected via a network (e.g. the Internet). The 4DHelp data vault may be an actual copy of the 4Dhelp data, or may be a pointer to a single copy shared by multiple users. Regardless of whether a copy or pointer is associated with the user account, the user may be able to make modifications to the 4DHelp associated with his or her account.

The Account Interface 926 may contain tools for creating new 4DHelp data which the user may use and optionally share with other users. The system may also allow for local storage of 4DHelp data on the User Device 910. The local storage may work in conjunction with the user account, as memory constraints may cause the local storage to contain only a subset of 4DHelp data associated with the user's account in the Data Repository system 920. The Data Repository system 920 may also have or be connected with a Third Party content Interface 927. This Interface 927 may be responsible for searching a network such as, for example the Internet, for 4DHelp data contained on the Data Repository system 920 and/or Third Party Data Repositories 930. The Interface 927 may also allow third parties to upload their content to the Data Repository system 920, or inform the Data Repository system 920 that content is available at the Third Party Data Repository 930a or 930b. The Third Party Data Repositories 930 may also have storage (e.g. a database) associated with them. This is only one example embodiment, and illustrates a primary central data repository system. Alternatively, the user specific tools may reside on user devices, and the user devices may connect directly (over a network such as the Internet shown as optional connection 950) with one or more Third Party Repositories 930. Additionally, optional connection 960 may allow the Processing Device with User Account Interface 926 to directly connect with the Third Party Interface 927 without having to go through the Data Repository 920. Additionally, the user devices may connect to both a central system and directly to third party systems without having to go through the central system.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A four dimensional information distribution system, comprising:
a user device for transmitting, receiving, and displaying content, said content comprising four dimensional information;
a processing device for receiving content requests from the user device and transmitting content; and
a data repository for storing the content accessible by said processing device.

2. The system of claim 1, wherein said processing device comprising user accounts configured to be associated with at least one set of four dimensional information manageable by a user.

3. The system of claim 2, wherein said user account is configured to allow a user to perform actions from the group consisting of associating new content with the account, disassociating content, searching for new content, creating new content, customizing or personalizing content, and modifying content.

4. The system of claim 2, where said processing device is configured to transmit advertisements.

5. The system of claim 4, wherein said advertisements are selected based, at least in part, on the content requested.

6. The system of claim 4, wherein said advertisements are selected based, at least in part, on the content associated with a specific user.

7. The system of claim 4, wherein said advertisements are selected based, at least in part, on the content being transmitted.

8. The system of claim 1, wherein said processing device is configured to search for four dimensional information.

9. The system of claim 1, further comprising:
a content creation tool for creating four dimensional information, wherein said content creation tool is configured to be available to users of the system.

10. The system of claim 1, further comprising:
an interface device, accessible by the processing device, configured to permit a third party to associate content with a user.

11. The system of claim 10, wherein the associate content comprises any one or more of the group consisting of downloading the content to a repository associated with the user, allowing the user to access the content, and facilitating communication regarding the content between the third party and the user.

12. The system of claim 1, wherein said data repository comprises one or more of the group consisting of a central database, a plurality of databases, and a distributed database.

13. The system of claim 1, wherein said database is accessible by the user device via a network.

14. The system of claim 1, wherein said data repository resides on a user device.

15. A method of distributing four dimensional information and creating a network, comprising:
maintaining a user base, said users associated with a repository of content or a repository of links to content, wherein said content includes four dimensional information; and
adding new content associated with a product to said user's repository when the user acquires the product.

16. The method of claim 15, further comprising:
associating said user with at least one other user, where the other user's repository has the same or similar content as the added content.

17. The method of claim 15, further comprising:
allowing said user to perform actions from the group consisting of associating new content with the account, disassociating content, searching for new content, creating new content, customizing or personalizing content, and modifying content;
allowing said user to interact with other users, including associated users.

18. A method of providing interactive help, comprising:
receiving a user information request for four dimensional information;
retrieving four dimensional information in response to a data retrieval request; and
sending four dimensional information to said user.

19. The method of claim 18, wherein said four dimensional information includes a link for contacting another person for help with the four dimensional information.

20. The method of claim 19, wherein said help from another person comprises a real-time connection to a customer service representative or technical assistance representative.

21. The method of claim 19, wherein help from another person comprises asynchronous communication, including sending an email, sending a text message, or being redirected to a discussion forum.

22. The method of claim 19, wherein said another person is another user who recently requested the same or similar four dimensional information.

23. The method of claim 19, wherein said another person is another user, wherein said another user is in the user's 4DHelp social network.
